(19) United States
(12) Patent Application Publication
(10) Pub. No.: US 2010/0193373 A1
(43) Pub. Date: Aug. 5, 2010

(54) METHOD OF REAR SURFACE TREATMENT, ANALYSIS METHOD OF INTEGRATED CIRCUIT FROM REAR SURFACE SIDE, AND REAR SURFACE TREATMENT APPARATUS

(75) Inventor: HIDEKI KITAHATA, KANAGAWA (JP)

Correspondence Address: YOUNG & THOMPSON, 209 Madison Street, Suite 500, Alexandria, VA, 22314, US

(73) Assignee: NEC ELECTRONICS CORPORATION, KANAGAWA (JP)

(21) Appl. No.: 12/700,898

(22) Filed: Feb. 5, 2010

(30) Foreign Application Priority Data
Feb. 5, 2009 (JP) 2009-24909

(51) Int. Cl. C25B 9/00; B23H 3/02; B23H 9/00

(52) U.S. Cl. 205/645; 205/655; 205/640; 204/242; 204/230.2

(57) ABSTRACT

A method of rear surface treatment is carried out by: preparing a semiconductor device in which an integrated circuit having a plurality of electrodes is provided on the front surface of a semiconductor substrate; electrically connecting the plurality of electrodes to an anode; and electropolishing the rear surface of the semiconductor substrate by performing anodic oxidation with an electrolytic solution placed in contact with the rear surface of the semiconductor substrate.

### BACKGROUND OF THE INVENTION

1. Field of the Invention

The present invention related to a method of rear surface treatment, an analysis method of an integrated circuit from rear surface side, and a rear surface treatment apparatus.

2. Description of the Related Art

Japanese Patent Laid-Open No. 2004-205440 describes a method for analyzing a defective part of a semiconductor device. In this method of defective part analysis, an opening is formed on the rear surface of an LSI chip, and then islands exposed in the opening are removed and a mirror-finished surface is realized by polishing the rear surface of the LSI chip exposed in the opening using a buff formed mainly of animal hair and the like, soaked with an abrading agent and shaped like a cotton-tipped swab. The semiconductor chip is placed in a predetermined operating state through a lead frame of a semiconductor package and light emission from a defective part of the semiconductor chip is detected from the rear surface side of the semiconductor chip, thereby analyzing the semiconductor chip. According to the document, the opening is formed from the rear surface side of the LSI chip without applying vibration, and light emission at the defective part is recognized. In addition, the document states that the rear surface side of the LSI chip is mirror-finished in order to prevent diffuse reflection.

In addition, Japanese Patent Laid-Open No. 2005-265829 describes a failure analysis method of a semiconductor element. In this failure analysis method, a semiconductor element is thin-filmed by rear surface polishing, so as to make it easy to observe a circuit-formed surface from the rear surface side of the semiconductor element. After that, observation and light emission analysis are performed on the circuit-formed surface of the semiconductor element to predict a failed part. Then, an extremely-small difference in potential and a value of electric current at the predicted failed part are measured to narrow the location of the failed part down to a transistor level. According to the document, the rear surface of the semiconductor element opposite to the circuit-formed surface thereof is ground and polished using abrasive tools to thin the semiconductor element.

Journal of the Electrochemical Society, Vol. 129, pp. 596-599 describes utilizing a porous silicon layer formed by anodic oxidation as an antireflection film of a solar cell. In this antireflection film of a solar cell, a platinum foil is bonded to the n-type surface of a solar cell in which a p-type layer is formed on one surface of an n-type silicon substrate by simultaneously diffusing phosphorous and boron, and the solar cell is soaked in hydrofluoric acid. After that, light is irradiated from the p-type surface using a tungsten lamp to make the solar cell generate electricity. Thus, the porous silicon layer is formed as the result of the p-type surface being anodized by the electrical generation of the solar cell itself.

Both of the polishing methods described in Japanese Patent Laid-Open Nos. 2004-205440 and 2005-265829 are mechanical polishing in which polishing is performed while applying local stress to the rear surface of an LSI chip. Accordingly, the risk of damaging the LSI chip becomes higher as a semiconductor substrate becomes thinner. In addition, if any crystal defects occur within the semiconductor substrate due to mechanical damage, though the semiconductor substrate may not crack completely, the number of failed parts increases or the state of failure changes. This makes it no longer possible to reproduce an original failure, thus possibly making it difficult to identify an original failed part.

### SUMMARY OF THE INVENTION

According to the present invention, there is provided a method of rear surface treatment, including: preparing a semiconductor device in which an integrated circuit having a plurality of electrodes is provided on the front surface of a semiconductor substrate; electrically connecting the plurality of electrodes to an anode; and electropolishing the rear surface of the semiconductor substrate by performing anodic oxidation with an electrolytic solution placed in contact with the rear surface.

Furthermore, according to the present invention, there is provided a failure analysis method of an integrated circuit from the rear surface side of a semiconductor substrate by irradiating light to the rear surface of the semiconductor substrate electropolished by the above-described method of rear surface treatment.

Still furthermore, according to the present invention, there is provided a rear surface treatment apparatus for the rear surface treatment of a semiconductor substrate of a semiconductor device in which an integrated circuit having a plurality of electrodes is provided on the front surface of the semiconductor substrate, the apparatus including:

a contact unit which brings an electrolytic solution into contact with the rear surface of the semiconductor substrate;

a cathode soaked in the electrolytic solution;

an anode electrically connected to the plurality of electrodes; and

a conduction unit which turns on an electric current between the cathode and the anode.

A plurality of electrode is electrically short-circuited in a random manner to achieve electrical connection by taking advantage of the fact that electrodes constituting an integrated circuit always include those connected by ohmic contact to a semiconductor substrate. Accordingly, electrical conduction to the substrate is possible even under the condition that the rear surface of the semiconductor substrate, on the front surface of which is provided an integrated circuit, is placed in contact with the electrolytic solution. Consequently, if the substrate is connected to an anode of an external power supply and the substrate's rear surface is anodized with the rear surface placed in contact with the electrolytic solution, a semiconductor is removed by electrical reaction at a portion of the rear surface with which the electrolytic solution is in contact and, thereby, the substrate's rear surface is electropolished.

According to the present invention, it is possible to treat the rear surface of a semiconductor substrate of a semiconductor device, while avoiding causing mechanical damage to the semiconductor substrate.

### BRIEF DESCRIPTION OF THE DRAWINGS

FIG. 1 is an overhead view illustrating a rear surface treatment apparatus in accordance with an embodiment of the present invention;

FIG. 2 is a schematic cross-sectional view illustrating a first application example of the rear surface treatment apparatus of the present invention;

FIG. 3 is a schematic cross-sectional view illustrating a second application example of the rear surface treatment apparatus of the present invention; and

FIG. 4 is a flowchart illustrating a method of rear surface treatment in accordance with an embodiment of the present invention.

### DETAILED DESCRIPTION OF THE PREFERRED EMBODIMENTS

Hereinafter, embodiments of the present invention will be described using the accompanying drawings. Note that throughout the drawings, the same component parts are denoted by the same reference numerals and will be omitted from the description as appropriate. In the present embodiment, an explanation will be made by prescribing a back-and-forth direction, a left-and-right direction and an up-and-down direction, as illustrated in the figure. However, this means that interrelation among component parts is prescribed for ease of explanation. Therefore, this prescription is not intended to define directions at the time of manufacturing or using a product for which the present invention is carried out.

### First Embodiment

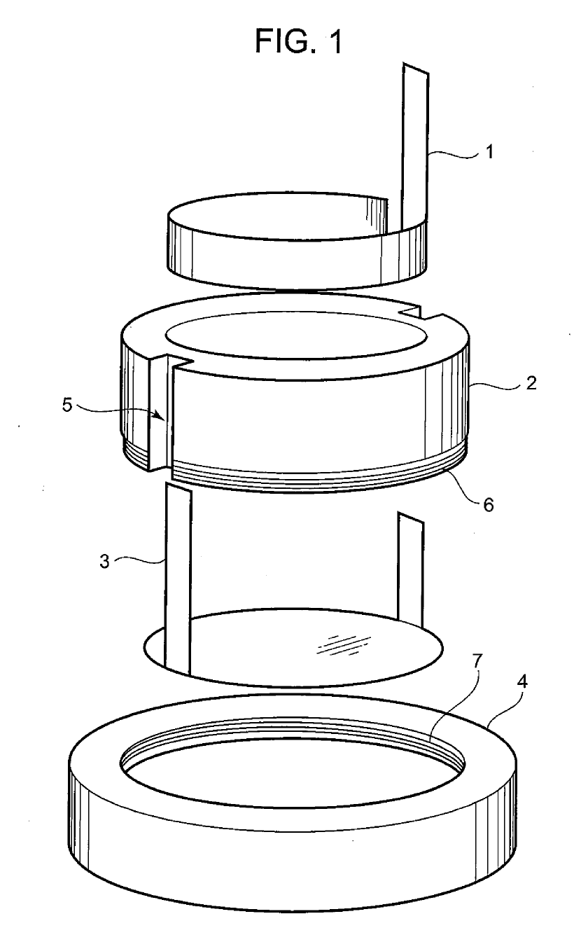

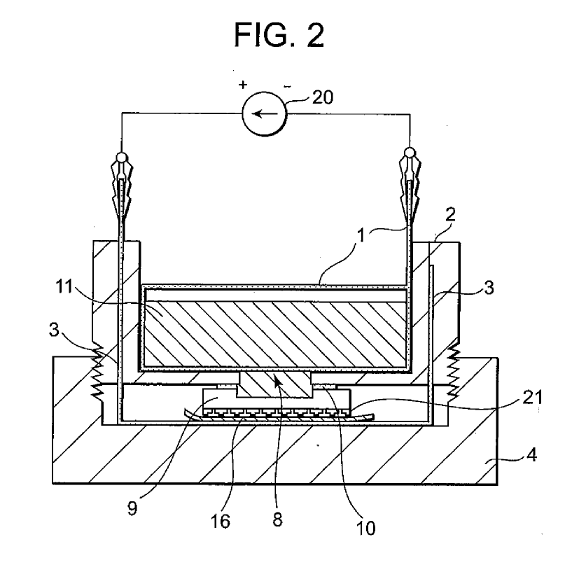

A rear surface treatment apparatus of the present embodiment will be described using FIGS. 1 and 2. FIG. 1 is an overhead view illustrating a configuration of the rear surface treatment apparatus of the present embodiment, whereas FIG. 2 is a schematic cross-sectional view illustrating the configuration of the rear surface treatment apparatus of the present embodiment.

The rear surface treatment apparatus is used to treat the rear surface of a semiconductor substrate of a semiconductor device in which an integrated circuit having a plurality of electrodes is provided on the front surface of the semiconductor substrate (silicon substrate). Here, the semiconductor device includes every form of device, such as a memory device, a logic device, and a hybrid device.

The rear surface treatment apparatus includes: a contact unit for bringing an electrolytic solution into contact with the rear surface of the semiconductor substrate; a cathode 1 soaked in the electrolytic solution; an anode 3 electrically connected to the plurality of electrodes; and a conduction unit for turning on an electric current between the cathode 1 and the anode 3.

The rear surface treatment apparatus of the present embodiment further includes a petri dish 2 (electrolysis vessel) and a cap 4 (fixing part), as illustrated in FIG. 1.

The cathode 1 is formed by bending the base of an L-shaped stainless-steel fitting into a hoop, so that the length of the L-shaped base is slightly smaller than the length of the inner circumference of the petri dish 2 and the diameter of the hoop is slightly larger than the inner diameter of the petri dish 2. The cathode 1 having such dimensions and a shape as described above is structured so that the portion bended into a hoop can be fixed onto the inner side of the petri dish 2 by taking advantage of the spring force of the portion. Since the cathode 1 comes into contact with hydrofluoric acid (electrolytic solution), it is preferable to coat the surfaces of the cathode 1 by platinum plating. The cathode 1 need not necessarily be platinum-plated, however, if an allowance is made for wear in the cathode due to corrosion and the cathode is replaced as necessary.

The petri dish 2 is made of Teflon (registered trademark) and an opening 8 (FIG. 2) for anodic oxidation is created in the bottom of the petri dish. In addition, guide grooves 5 to insert the anode 3 into are formed on the outer side of the petri dish 2, and a male thread 6 to mount the cap 4 thereon is formed in the bottom of the outer side. By pooling an electrolytic solution in the opening 8 with the opening 8 for anodic oxidation blocked up with the rear surface of the silicon chip 9, it is possible to bring part of the rear surface (portion to be anodized) of the silicon substrate of the silicon chip 9 into contact with the electrolytic solution (FIG. 2).

In addition, the cathode 1 to be fixed onto the inner side of the petri dish 2 is located so as not to make a shadow in the opening for anodic oxidation, so that the observation of the condition of anodic oxidation using an optical unit or light irradiation to a portion being anodized using an unillustrated light source is possible from above the cathode 1. Accordingly, light enters from the upper opening of the petri dish 2, passes through the opening, and reaches the rear surface of the silicon substrate of the silicon chip 9.

The anode 3 is a O-shaped stainless-steel fitting and has a structure in which the straight-line portions of the fitting are bended at a right angle with respect to the circular portion of the fitting. The diameter of the circular portion is equal to a spacing between the guide grooves 5 of the petri dish 2. By inserting the straight-line portions into the guide grooves 5 from the lower side of the petri dish 2, the anode 3 is mounted in such a manner that the circular portion covers the opening 8 for anodic oxidation in the bottom of the petri dish 2 (FIG. 2).

As illustrated in FIG. 1, the cap 4 is made of Teflon (registered trademark) and a female thread 7 to mount the cap 4 on the petri dish 2 is formed on the inner side of the cap 4. In such a configuration as described above, if the cap 4 is mounted on the petri dish 2 and rotated so as to be tightened, the anode 3 is pressed against the bottom face of the petri dish 2 along the guide grooves 5 without being rotated. As described above, the cap 4 may have a bottom face to have contact with the plane surface of the anode 3 and a thread mechanism to engage with the petri dish 2. The cap 4 is provided so as to be detachable from the petri dish 2 and is fixed while pressing the silicon chip 9, so that the opening 8 (FIG. 2) is blocked up with the rear surface of the silicon substrate (contact unit).

Subsequently, a description will be given of a method of rear surface treatment of the present embodiment.

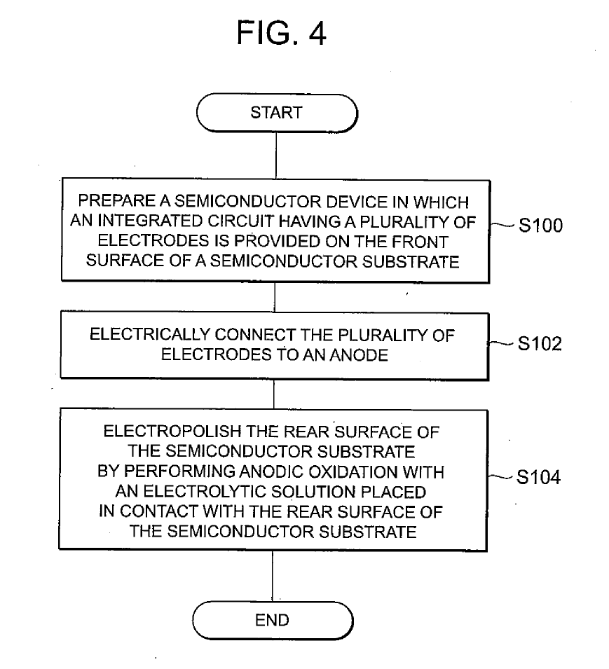

FIG. 4 is a flowchart illustrating the method of rear surface treatment in accordance with an embodiment of the present invention.

The method of rear surface treatment of the present embodiment is carried out by: preparing a semiconductor device in which an integrated circuit having a plurality of electrodes is provided on the front surface of a semiconductor substrate (S100); electrically connecting the plurality of electrodes to an anode (S102); and electropolishing the rear surface of the semiconductor substrate by performing anodic oxidation with an electrolytic solution placed in contact with the rear surface (S104).

FIG. 2 illustrates a first application example in which the method of rear surface treatment of the present embodiment is carried out using the rear surface treatment apparatus illustrated in FIG. 1.

In the first application example, the uppermost-layer electrodes of the integrated circuit provided on the front surface of the silicon substrate are used as the above-described electrodes 21 (S100). In addition, in the present embodiment, hydrofluoric acid 11 is used as the electrolytic solution.

The silicon chip 9 is pressed with the anode 3 from below the petri dish 2 and fixed, so as to block up the opening 8 created in the bottom of the petri dish 2 with the rear surface of the semiconductor substrate (silicon substrate) of the silicon chip 9 (a semiconductor device in which an integrated circuit having a plurality of electrodes is provided on the front surface of a semiconductor substrate). At this time, acid-proof grease 10 is first applied to a peripheral part of the opening 8 in the bottom face of the petri dish 2, and then the rear surface of the silicon chip 9 is lightly pressed against the acid-proof grease 10 and is thus fixed temporarily. By fastening the anode 3 from below with the cap 4 after mounting the anode 3 on the petri dish 2, the rear surface of the silicon chip 9 is brought into close contact with the bottom face of the petri dish 2. In addition, the cathode 1 and the anode 3 are electrically connected to a current source 20 (conduction unit) (S102).

Consequently, almost all the electrodes of the integrated circuit formed on the front surface of the silicon chip 9 are electrically connected to the anode 3. In addition, by inserting a conductive sheet, such as an aluminum foil 16, between the silicon chip 9 and the anode 3 by taking advantage of the pressing action of the cap 4, it is possible to ensure more reliable contact with electrodes located all over the front surface of the silicon chip 9. Note however that this method is only effective if electrodes protrude above the uppermost layer of an LSI chip, as in the case of a flip chip. In the case of an LSI chip in which an insulating film covering the uppermost layer protrudes higher than electrodes, it is possible to use a conductive paste in place of the aluminum foil 16. This conductive paste is removed by cleaning the LSI chip after the completion of rear surface treatment.

Next, the hydrofluoric acid 11, approximately 50% in concentration, is fed into the petri dish 2 with the opening 8 blocked up with the rear surface of the silicon chip 9, thereby pooling the electrolytic solution in the opening 8. If the rear surface of the silicon chip 9 is anodized under an intense electric field condition by applying a positive current to the anode and a negative current to the cathode with the hydrofluoric acid 11 placed in contact with a portion of the silicon substrate's rear surface on which anodic oxidation is to be performed, the rear surface of the silicon substrate is electropolished (S104). Thus, the semiconductor substrate is thinned and, at the same time, the rear surface thereof is mirror-finished.

At this time, it is preferable, in terms of uniformity, to apply ultrasonic vibration to the device as a whole, so that hydrogen gas bubbles produced as the result of anodic oxidation being performed do not stay on the rear surface of the silicon substrate. By monitoring interference color from above the petri dish 2 using an optical unit and confirming that the silicon substrate turns red, it is also possible to control a substrate thickness to a tolerance of approximately 1 μm. Consequently, even a high impurity concentration silicon substrate difficult for light to transmit through can be reliably thinned to such a substrate thickness as to enable backside analysis.

In addition, if the mirror-finished region of the rear surface of the silicon chip 9 is anodized, as necessary, under a low electric field condition, a porous silicon layer is formed (transformation of a portion of the rear surface of the silicon chip 9 into a porous structure). This porous layer is a mixture of air and silicon and, therefore, has a refractive index intermediate between those of air and silicon. The porous layer can be utilized as an antireflection film by monitoring interference color from above the petri dish 2 using an optical unit and controlling the porous layer to a desired film thickness. The density of the porous silicon layer can be controlled under a low electric field condition.

In the present embodiment, a boundary face between silicon and hydrofluoric acid can be regarded as a Schottky junction. Accordingly, an electric field applied to the junction is referred to as a strong electric field or a weak electric field in terms of modeling. Strong and weak electric field conditions can be determined as described below, according to electropolishing or pore-forming treatment.

An electric field condition depends on an anode potential and can be determined by a current density according to the concentration of hydrofluoric acid. By adjusting the anode potential to within a predetermined range, electropolishing and pore-forming treatment can be roughly distinguished from each other and performed. For example, the anode potential of electropolishing is set to approximately 6 V or higher and the anode potential of pore-forming treatment is set to approximately 3 V or lower. By controlling a value of electric current and adjusting a current density within the range of each anode potential, it is possible to realize a desired electric field condition.

Here, the anode potential can be obtained by measuring a potential difference between the anode 3 and the cathode 1.

Under a strong electric field condition, it is possible to perform stable electropolishing by maintaining the anode 3 at an appropriate current density for a sufficiently-high applied voltage set by taking into consideration a voltage drop due to parasitic resistance (resistance of electrolytic solution, contact resistance, conductor resistance, and the like) on the condition that the anode potential is within the range of approximately 6 V or higher.

In addition, the rate of electropolishing depends on a current density. Accordingly, in a case where a current density is optimized under a strong electric field condition, adjusting the concentration of hydrofluoric acid widens the range of controllable polishing rates. Electropolishing does not progress, however, if the concentration of hydrofluoric acid is too low. Accordingly, the concentration of hydrofluoric acid is set to, for example, 2.5% or higher.

If a polishing rate needs to be decreased in electropolishing, for example, in order to control a remaining thickness (amount of polishing), it is conceivable to lower the concentration of hydrofluoric acid. However, since one advantage of this method is that the polishing rate is high, a possible alternative to this method is to replace the hydrofluoric acid with hydrofluoric acid of a low concentration (5% or so, since electropolishing does not take place if the concentration is excessively lowered) in a final stage.

Under a weak electric field condition, it is possible to perform stable pore-forming treatment by maintaining the anode 3 at an appropriate current density for a sufficiently-low applied voltage on the condition that the anode potential is approximately 3 V or lower. If an antireflection film is formed in a silicon layer by performing pore-forming treatment, for example, it is better to lower the current density and increase a treatment time, in order to make it easy to control the thickness of an antireflection film. This enables the formation of a highly-reproducible antireflection film and stable antireflection.

Note that if the anode potential is within the range of 3 V to 6 V, close to a boundary condition between strong and weak electric fields, a low-density layer exhibiting a refractive index off from a refractive index optimum for an antireflection film and closer to that of air than that of silicon is formed on a portion of the rear surface of the silicon chip 9. Accordingly, the anode potential at the time of pore-forming treatment is preferably approximately 3 V or lower and the anode potential at the time of electropolishing is preferably approximately 6 V or higher.

Here, the rear surface treatment apparatus of the present embodiment may further include an unillustrated current control section (control unit).

This current control section (control unit) actually controls the current source 20, so that an electric current corresponding to an electric field condition at the time of electropolishing is applied from the current source 20. That is, the current control section controls the current source 20 to change the value of an electric current flowed from the current source 20 to a desired new electric current value, thereby flowing an electric current having this value. In the present embodiment, a DC current is used.

The rear surface treatment apparatus performs a process sequence including steps (a) and (b) described below:

(a) a step of electropolishing the rear surface of the silicon chip 9 by performing anodic oxidation with the hydrofluoric acid 11 (electrolytic solution) placed in contact with the rear surface; and
(b) a step of further performing anodic oxidation after electropolishing at a potential (approximately 3 V or lower) lower than the potential of the anode 3 (approximately 6 V or higher) at the time of electropolishing with the hydrofluoric acid 11 placed in contact with the rear surface silicon chip 9, thereby making a portion of the rear surface porous.

This process sequence is performed by the current control section (not illustrated) within the rear surface treatment apparatus. The current control section may control the overall ranges of the above-described steps (a) and (b), so that all treatments are performed automatically, or may control part of the steps. In addition, the process sequence may be performed continuously.

For example, the rear surface treatment apparatus of the present embodiment can be provided with a voltmeter (not illustrated) for detecting a potential difference between the anode 3 and the cathode 1. Consequently, in the rear surface treatment apparatus, the voltmeter detects a potential difference between the anode 3 and the cathode 1. By feeding back this voltage value to the current control section, the current control section is made to automatically correct the value of output current, so that the potential difference is maintained against the voltage and parasitic resistance variations of the current source 20 being controlled.

With the current control section, it is possible to make the potential of the anode 3 maintained at approximately 6 V or higher in an electropolishing step and maintained at a lower potential of approximately 3 V or lower in a later step of making the rear surface porous. In addition, the current control section controls a value of electric current, so that a current density is kept constant within this anode potential range.

For example, in the rear surface treatment apparatus, a constant current source may be used as the current source 20 and may be made to perform current control based on the constant current source. Constant current control allows the constant current source to be maintained at a constant current density as long as the area of anodic oxidation is kept constant. Accordingly, it is possible to keep constant the rate of anodic oxidation, i.e., an electric field to be actually applied to a portion being anodized. Since the rear surface treatment apparatus is configured so that the area of anodic oxidation is defined by the opening 8 on the apparatus side, stable anodic oxidation is performed by optimizing the electric current value according to the size of the opening 8.

In order to mirror-finish the rear surface of the silicon chip 9 and form a porous layer in a continuous manner, it is preferable to use a solution containing the hydrofluoric acid 11 as the electrolytic solution. In addition, the solution containing the hydrofluoric acid 11 may contain such an additive as ethanol, ammonia fluoride, or the like to the extent of not causing any practical problems. The concentration of the hydrofluoric acid 11 can be adjusted using H₂O or the like.

Note that since electron holes are involved in the electropolishing and pore formation of the silicon substrate, the above-described method of anodic oxidation can be utilized for a p-type silicon substrate. Rear surface treatment can also be performed by anodic oxidation on an n-type silicon substrate, in the same way as on the p-type silicon substrate, by irradiating light to the rear surface of the silicon chip 9 from above the petri dish 2 and performing photosensitized electrolytic oxidation.

Note that the rear surface treatment apparatus of the present embodiment can be provided with an unillustrated light source. As the light source, it is possible to use a tungsten lamp, a monochromatic light source (e.g., laser) or the like. This light source is used to irradiate light from above the petri dish 2 to the rear surface of the silicon chip 9. The light irradiated from this light source passes through the opening 8 from the upper opening of the petri dish 2, and reaches the above-mentioned rear surface.

Now a description will be given of the operational effects of embodiments of the present invention.

Almost all the electrodes are electrically short-circuited in a random manner to achieve electrical connection by taking advantage of the fact that electrodes 21 constituting the uppermost layer of an integrated circuit always include those connected by ohmic contact to a silicon substrate. Accordingly, electrical conduction to the substrate is possible even under the condition that the rear surface of the LSI chip, on the front surface of which is formed the integrated circuit, is soaked in an electrolytic solution. Thus, it is possible to connect the substrate of the LSI chip to the anode 3 of an external power supply. Under normal conditions, the silicon substrate is connected to a ground potential. In order to stabilize the operation of the integrated circuit, however, it is possible to uniformly anodize the substrate's rear surface if an electric current is supplied to the anode through a ground electrode, since such portions in ohmic contact with the silicon substrate as described above are located all over the front surface of the LSI chip. In addition, by electrically short-circuiting almost all the electrodes of the LSI chip beforehand, there can also be attained the effect of avoiding to cause electrical damage to the integrated circuit during anodic oxidation. Accordingly, it is possible to reduce the risk that a new failed part or parts arise in the LSI chip or the fault condition changes during rear surface treatment.

By pressing an electrode having a plane surface to serve as the anode 3 against the LSI chip, almost all of the electrodes of the LSI chip are short-circuited and, at the same time, electrically connected to the anode 3. In addition, the rear surface of the LSI chip is pressed against the opening 8 for anodic oxidation of the rear surface treatment apparatus to fix the LSI chip by taking advantage of this force of pressing the electrode having a plane surface. Thus, it is possible to easily construct a cell for anodic oxidation in a short period of time.

As has been described heretofore, the method of rear surface treatment of the present embodiment is devised so that an anodic oxidation method can be applied to the rear surface treatments of a substrate for backside analysis, such as thinning, mirror finish, and the like. Accordingly, no mechanical damage is caused to the LSI chip, and it is possible to avoid risks associated with thinning and safely fabricate a sample for backside analysis.

If silicon is anodized with a weak electric field, a porous layer is formed on a silicon surface. By utilizing this porous layer of silicon as an antireflection film, it is possible to perform a series of rear surface treatments of a substrate, including lamination processing, mirror finish and antireflection, within the same equipment. Thus, it is possible to simultaneously achieve reduction in both the cost and time of analysis.

Here, as an antireflection film in a boundary face between silicon having a refractive index of 3.5 and air having a refractive index of 1, it is preferable to use a film whose refractive index equals a geometrical average of 1.87 of the refractive indexes of these substances. Since the porous film of silicon of the present embodiment is a mixture of silicon and air and, therefore, has a refractive index intermediate between those of silicon and air. Thus, the porous silicon film can be utilized as an antireflection film.

In addition, according to the method of rear surface treatment of the present embodiment, it is possible to realize a series of rear surface treatments of a substrate for backside analysis, including thinning, mirror finish and antireflection, within the same equipment by changing an anodic oxidation condition (electric field condition). Accordingly, it is possible to perform a series of rear surface treatments of a substrate in a simple and convenient manner within the same equipment. This makes it possible to reduce both the cost and time of failure analysis. In addition, there is no need to line up individual units of equipment, tools, consumables, and the like for each step, thereby enabling reduction in the cost of analysis. In this way, it is possible to efficiently perform rear surface treatments of a substrate.

Next, a description will further be given of the advantages of the present embodiment, while making a comparison with conventional techniques.

The method for forming a porous silicon layer described in Journal of the Electrochemical Society, Vol. 129, pp. 596-599 is a method which is specific to a solar cell and takes advantage of electric generation by the solar cell itself. For this reason, the method is not applicable to the silicon substrate of an LSI chip on one surface of which is formed an integrated circuit.

In contrast, in the present embodiment, a plurality of electrodes is electrically connected to the anode 3 and silicon in the rear surface is anodized with a weak electric field with the hydrofluoric acid 11 placed in contact with the rear surface of the silicon substrate of an LSI chip on one surface of which is provided an integrated circuit, as described above, thereby making it possible to form a porous layer on a surface of the silicon.

Conventionally, an antireflection film for backside analysis of an LSI chip has been formed using an electron beam evaporation method, a sputtering method, or the like. Although polishing methods used in mirror-surface processing and thinning processing are of the same sort, it is more efficient to use fine abrasive grains for mirror-surface processing since mirror-surface processing is final polishing, and use coarse abrasive grains for polishing performed to thin a substrate. Accordingly, different abrading agents and abrasive tools must be prepared in these respective steps, in order to process a substrate into a thin structure and then finish the rear surface thereof into a mirror surface. Furthermore, scratches will remain if mirror polishing is performed with coarse abrasive grains adhering to the rear surface of the substrate. Consequently, there arises the need for a step of removing coarse abrasive grains by ultrasonic cleaning or the like before entering a step of mirror polishing. Still furthermore, it is necessary to do work in equipment, such as an electron beam evaporation apparatus or a sputtering apparatus, separate from a polishing apparatus after mirror polishing, in order to achieve antireflection. If a switch is made in midstream from one unit of equipment to another, additional work becomes necessary along with the startup and shutdown of respective units of equipment, the fixation and removal of a sample, and the like, as compared with a case in which work is done in the same equipment. That is, units of equipment, tools, consumables and the like need to be lined up in each step when a series of rear surface treatments of a substrate, including thinning, mirror finish and antireflection, is performed. This has been a cause for giving rise to the problem that the cost of analysis becomes expensive. In addition, doing work in individual units of equipment causes the work to become cumbersome and complicated and the time of failure analysis to become longer.

In contrast, in the method of rear surface treatment of the present embodiment, it is possible to realize a series of rear surface treatments of a substrate for backside analysis, including thinning, mirror finish and antireflection, within the same equipment by changing an anodic oxidation condition. Accordingly, it is possible to perform a series of rear surface treatments of a substrate in a simple and convenient manner within the same equipment. This makes it possible to reduce both the cost and time of failure analysis. In addition, there is no need to line up individual units of equipment, tools, consumables, and the like in each step, thereby enabling reduction in the cost of analysis.

In order to anodize a silicon substrate, rather than a semiconductor device, it is considered necessary to form a dummy metal film on one surface of the silicon substrate and bring an electrolytic solution into contact with the other surface, with this metal film and an anode connected to each other. Consequently, there has been the problem that the step of forming the metal film adds to the number of work steps to be carried out before anodic oxidation.

In contrast, in the present embodiment, the silicon substrate of a semiconductor device is used and almost all the electrodes are electrically short-circuited in a random manner to achieve electrical connection by taking advantage of the fact that electrodes constituting the uppermost layer of an integrated circuit formed on the front surface of this silicon substrate always include those connected by ohmic contact to the silicon substrate. Accordingly, electrical conduction to the substrate is possible even under the condition that the rear surface of the LSI chip, on the front surface of which is formed an integrated circuit, is soaked in an electrolytic solution. This makes it possible to connect the substrate of the LSI chip to the anode 3 of an external power supply. Thus, it is possible to perform rear surface treatment on the silicon substrate of the semiconductor device in a simple and convenient manner.

The rear surface treatment apparatus of the present embodiment is applicable to not only such a bare chip as mentioned in the first application example but also an LSI chip mounted in a package. A package in which ball terminals are arranged on the front surface side of an LSI chip like a flip chip BGA (ball grid array) is equivalent in configuration to a bare chip, if the rear surface of the LSI chip is exposed and the ball terminals are regarded as the electrodes of the LSI chip. Accordingly, the rear surface of the LSI chip can be anodized in the same way as in the above-described first application example.

### Second Embodiment

Now, a description will be given of a second application example in which a method of rear surface treatment of the present embodiment is carried out.

In the second application example, the rear surface treatment apparatus of the present embodiment is applied to an LSI chip mounted in a QFP (quad flat package) which, if left mounted in a package, is not equivalent in configuration to a bare chip.

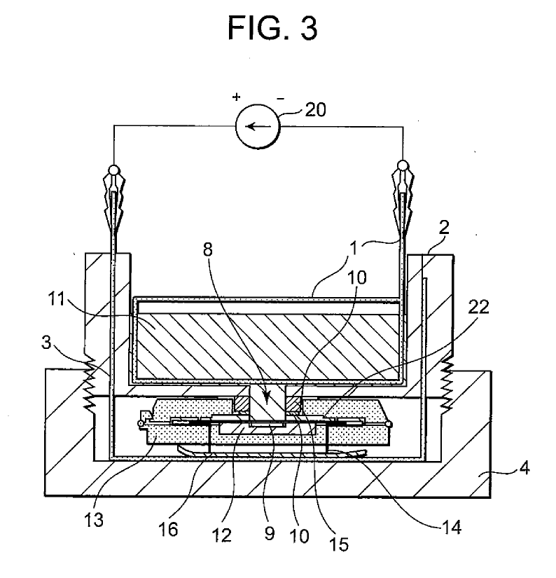

FIG. 3 illustrates the second application example of an anodic oxidation method which uses the rear surface treatment apparatus of FIG. 1.

A QFP 12 is partially opened at the rear surface thereof beforehand, so that the rear surface of a silicon chip 9 becomes exposed. This QFP 12 is mounted on a socket 13 for backside analysis.

The socket 13 for backside analysis is of such a type that a central part of the top cover of a regular socket for testing is opened. By mounting the QFP 12 with the front and rear surfaces thereof reversed, it is possible to observe the rear surface of the silicon chip 9 exposed by partial opening from the opening of the top cover. As this socket 13 for backside analysis, it is possible to use a commercially-available socket.

In the bottom face of the socket 13, there are provided pins 14 for mounting the socket on a test board, and each pin is electrically connected to a lead of the QFP 12. Accordingly, by mounting the QFP 12 on the socket 13 with the rear surface of the QFP 12 facing up, it is possible to realize a condition in which the rear surface of the silicon chip 9 is held upside and the pins 14 electrically connected to the electrodes of the silicon chip 9 are held in the bottom face of the socket 13. That is, it is possible to realize a configuration equivalent to that of a bare chip.

However, since the rear surface of the silicon chip 9 is surrounded by the bottom of the QFP 12 and the top cover of the socket 13, it is not possible to block up an opening 8 created in the bottom of a petri dish 2 with the rear surface of the silicon chip 9 if the apparatus is left as is. Hence, the opening 8 is blocked up with the rear surface of the silicon chip 9 through a tubular spacer 15 identical in cross-sectional shape to the opening 8 and made of Teflon (registered trademark).

The petri dish 2 and the spacer 15 and the spacer 15 and the QFP 12 are respectively brought into close contact with each other through acid-proof grease 10. Furthermore, the acid-proof grease 10 is also applied to portions of the bottom of the QFP 12 around the silicon chip 9 exposed inside the opening 8, so that the QFP 12 is not directly exposed to the hydrofluoric acid 11.

With the apparatus configured as described above, the anode 3 is mounted on the petri dish 2 and then fastened from below with a cap 4, so that the rear surface of the silicon chip 9 is brought into close contact with the bottom face of the petri dish 2 through the spacer 15. Consequently, almost all the electrodes of an integrated circuit formed on the front surface of the silicon chip 9 are electrically connected to the anode 3 through bonding wires inside the QFP 12, leads 22, contact terminals inside the socket 13, and the pins 14. By inserting an aluminum foil 16 between the pins 14 and the anode 3, it is possible for the anode to more reliably have contact with all of the pins 14. In this way, the electrodes of the integrated circuit are electrically connected to the anode 3 through the bonding wires, the leads 22, the contact terminals inside the socket 13, and the pins 14. In addition, a cathode 1 and the anode 3 are electrically connected to a current source 20. Hereinafter, it is possible to perform a series of rear surface treatments of a silicon substrate, including thinning, mirror finish and antireflection, by following the same procedure as that of the first application example. In the second application example, there is attained the same effect as that of the above-described first application example of the present embodiment.

The present invention is not limited to the above-described embodiments but may be modified in various other ways.

The method of rear surface treatment of the present embodiment is a method for the failure analysis of LSIs and the forms of LSIs subject to failure analysis range widely, from those in a wafer state to those in a packaged state. The first application example is applicable to almost all of the forms by, for example, cutting out a portion containing a chip to be analyzed from a wafer or fully opening a package to turn an LSI into a bare chip.

If a package is responsible for the cause of failure, however, the LSI may fail to reproduce failure if changed from a packaged state to a bare chip state. Thus, changing the form of the LSI under the circumstances in which the cause of failure is uncertain involves risks. In addition, a dedicated prober is required, for example, in order to reproduce failure in a bare chip state in backside analysis after rear surface treatment. Accordingly, failure analysis in a bare chip state may be difficult to perform in some cases, depending on the environment of failure analysis.

The second application example, which requires preparing a socket and a spacer, proves that the method of rear surface treatment of the present embodiment is still applicable even if failure analysis is performed with an LSI left in a packaged state.

The method for the failure analysis of an integrated circuit in accordance with the present embodiment is intended to analyze the integrated circuit from the rear surface side of the semiconductor substrate by irradiating light to the rear surface of a semiconductor substrate electropolished by the above-described method of rear surface treatment.

In addition, the failure analysis method is intended to analyze the integrated circuit form the rear surface side of the semiconductor substrate by irradiating light to a portion of the rear surface made porous by further performing anodic oxidation, after electropolishing, at a potential lower than an anode potential at the time of electropolishing with an electrolytic solution placed in contact with the rear surface of the semiconductor substrate.

In the present analysis method, it is possible to analyze the integrated circuit on the semiconductor substrate by detecting light emission of a defective part from the rear surface side of the semiconductor substrate.

By preparing the silicon chip 9 on which the rear surface treatment of the present embodiment has been performed, the QFP 12, and the like and using an EMS (Emission Microscope) method, an OBIRCH (Optical Beam Induced Resistance Change) method, or the like as a failure analysis method for an integrated circuit which utilize infrared light highly transmissive with respect to semiconductors, for example, it is possible to carry out a method for detecting a detective part from the rear surface of a chip (method of backside analysis).

If the rear surface of a semiconductor substrate is roughened, there arises the problem, for example, that the efficiency of detecting a failed part decreases due to light scattering and, in the worst case, it is no longer possible to observe a substrate surface from the rear surface of a substrate. In order to prevent the problem, mirror-surface processing for planarizing the rear surface of the silicon substrate is performed using the method of rear surface treatment of the present embodiment. In addition, in order to prevent the sensitivity of detecting a failed part from degrading as the result of light intensity attenuation due to light absorption within the substrate or reflection at the rear surface of the substrate, the substrate is previously thinned before mirror polishing. It is particularly effective to make the substrate thinner in a case where a semiconductor having a high impurity concentration is used for the substrate. Even in the case of a semiconductor having a low impurity concentration, it is possible to attain the effect of preventing resolution degradation due to a substrate's aberration by making the substrate thinner. Recently, an analysis apparatus provided with a backside analysis lens having an aberration-correcting function has been available commercially. From the viewpoint of detection sensitivity, however, it is advantageous to thin the substrate and then make aberration corrections. In addition, in order to suppress reflection at the rear surface of a substrate and increase the sensitivity of defecting a failed part, it is effective to perform an antireflection treatment on the rear surface of a silicon substrate using the method of rear surface treatment of the present embodiment.

Here, an explanation will be made of the above-mentioned EMS method. Current leakage failure is usually accompanied by extremely weak light emission due to the generation of hot electrons or the recombination of minor carriers. In the EMS method, it is possible to detect this extremely weak light emission and identify a failed part to a positional accuracy of submicrons with an ultrasensitive cooled CCD camera having effective sensitivity covering from visible light to near-infrared light. This CCD camera can detect near-infrared light transmitting through a silicon substrate, thereby making it possible to detect light emission associated with failure from a chip's rear surface.

An explanation will also be made of the above-mentioned OBIRCH method. If a laser beam is irradiated to the device under test, part of energy is converted into heat and the resistance of the location in question changes. The resistance change causes a change in an electric current. By displaying such a change in an electric current as a brightness variation, it is possible to obtain an OBIRCH image. The amount of electric current change depends on the temperature coefficient of resistance (TCR) of a location being irradiated. Accordingly, the location is displayed at high brightness if the electric current change is positive and displayed at low brightness if the electric current change is negative. If any voids exist in interconnects or vias, the decreasing rate of electric current increases since thermal conduction is impaired at the time of heating and, therefore, the location is displayed dark. If a high-resistance layer is present in a via bottom or the like, the TCR becomes negative and, therefore, the location is displayed brighter than usual. Consequently, it is possible to detect locations where any voids or low-resistance layers are present.

What is claimed is:

1. A method of rear surface treatment, comprising:
preparing a semiconductor device in which an integrated circuit having a plurality of electrodes is provided on the front surface of a semiconductor substrate;
electrically connecting said plurality of electrodes to an anode; and
electropolishing the rear surface of said semiconductor substrate by performing anodic oxidation with an electrolytic solution placed in contact with said rear surface.

2. The method of rear surface treatment according to claim 1, wherein said anode is pressed against all of said plurality of electrodes constituting the uppermost layer of said integrated circuit.

3. The method of rear surface treatment according to claim 1, wherein anodic oxidation is further performed after electropolishing at a potential lower than the potential of said anode at the time of electropolishing with said electrolytic solution placed in contact with said rear surface, thereby making a portion of said rear surface porous.

4. The method of rear surface treatment according to claim 1, wherein light is irradiated to said rear surface of said semiconductor substrate at the time of anodic oxidation.

5. The method of rear surface treatment according to claim 1, wherein said electrodes are pressed against said anode through a conductive sheet inserted between said electrodes and said anode.

6. An analysis method comprising the steps of:
preparing a semiconductor device in which an integrated circuit having a plurality of electrodes is provided on the front surface of a semiconductor substrate;
electrically connecting said plurality of electrodes to an anode;
electropolishing said rear surface of said semiconductor substrate by performing anodic oxidation with an electrolytic solution placed in contact with said rear surface; followed by the step of:
irradiating light to said electropolished rear surface of said semiconductor substrate, thereby analyzing said integrated circuit from said rear surface side of said semiconductor substrate.

7. The analysis method according to claim 6, wherein said light is irradiated to said portion of said rear surface made porous by further performing anodic oxidation, after electropolishing, at a potential lower than the potential of said anode at the time of electropolishing with said electrolytic solution placed in contact with said rear surface, thereby analyzing said rear surface of said semiconductor substrate.

8. A rear surface treatment apparatus for the semiconductor substrate of a semiconductor device in which an integrated circuit having a plurality of electrodes is provided on the front surface of said semiconductor substrate, said apparatus comprising:
a contact unit which brings an electrolytic solution into contact with the rear surface of said semiconductor substrate;
a cathode soaked in said electrolytic solution;
an anode electrically connected to said plurality of electrodes; and
a conduction unit which turns on an electric current between said cathode and said anode.

9. The rear surface treatment apparatus according to claim 8, wherein said contact unit includes:
an electrolysis vessel in the bottom of which is provided an opening; and
a fixing part which presses and fixes said semiconductor device, so as to block up said opening with said rear surface of said semiconductor substrate;
and said electrolytic solution is brought into contact with said rear surface of said semiconductor substrate by pooling said electrolytic solution in said opening.

10. The rear surface treatment apparatus according to claim 8, wherein said anode has a plane surface provided so as to cover all of said plurality of electrodes.

11. The rear surface treatment apparatus according to claim 9, wherein said fixing part fixes said anode by pressing said electrodes against said anode through a conductive sheet inserted between said electrodes and said anode.

12. The rear surface treatment apparatus according to claim 8, further comprising a control unit which controls the value of an electric current so that the potential of said anode is maintained lower than the potential of said anode at the time of electropolishing.

13. The rear surface treatment apparatus according to claim 9, further comprising a light source which irradiates light to said rear surface of said semiconductor substrate, wherein said light irradiated from said light source passes through said opening from the upper opening of said electrolysis vessel, and reaches said rear surface.
